(19) United States
(12) Patent Application Publication
(10) Pub. No.: US 2015/0020631 A1
(43) Pub. Date: Jan. 22, 2015

(54) ROTATING STRUCTURE OF WEIGHT FOR MANUAL TRANSMISSION

(71) Applicant: Hyundai Motor Company, Seoul (KR)

(72) Inventor: Young Bae Ryu, Seoul (KR)

(73) Assignee: Hyundai Motor Company, Seoul (KR)

(21) Appl. No.: 14/065,077

(22) Filed: Oct. 28, 2013

(30) Foreign Application Priority Data
Jul. 17, 2013 (KR) 10-2013-0084066

(51) Int. Cl. F16H 59/02

(52) U.S. Cl. CPC F16H 59/02
USPC 74/473.1

(57) ABSTRACT

A rotating structure of a weight for a manual transmission includes a shift lever connected to a control shaft mounted in a control housing of the manual transmission and binding a shift stage selected by a select lever, a first gear part inserted into the control shaft to be operated together with the shift lever and having gears formed on its outer peripheral surface, a weight provided at one end of the shift lever and increasing rotational inertial force of the shift lever, and a second gear part connected to the weight and having gears formed on its outer peripheral surface to be engaged with the first gear part.

### CROSS-REFERENCE TO RELATED APPLICATION

The present application claims priority of Korean Patent Application Number No. 10-2013-0084066 filed on Jul. 17, 2013, the entire contents of which application are incorporated herein for all purposes by this reference.

### BACKGROUND OF INVENTION

1. Field of Invention

The present invention relates to a rotating structure of a weight for a manual transmission, and more particularly, to a rotating structure of a weight for a manual transmission capable of increasing rotational inertial force of the weight through a gear ratio by gear-combining a shift lever and the weight of a control mechanism of the manual transmission with each other.

2. Description of Related Art

Generally, a transmission receiving a rotation speed signal of an engine to perform a speed shift is provided between a clutch and a driving shaft of a vehicle. Particularly, in the case in which the transmission is a manual transmission, a transmission manipulating device is provided so that a driver may manipulate the transmission according to a driving state of the vehicle.

More specifically, the transmission manipulating device is connected to a change lever directly manipulated by the driver by a control cable and enables manipulation of the transmission. In addition, the transmission manipulating device includes a select lever selecting a shift stage, a shift lever connected to the selected shift state, and a control shaft operated by the select lever and the shift lever.

In a rotating structure of a weight for a manual transmission according to the related art, as shown in FIG. 1, a shift lever 10 and a weight 20 are connected to each other through a pin P, such that when the shift lever 10 is rotated, the weight 20 is also rotated to improve shift feeling by mass.

However, according to the related art, as shown in FIG. 2, relative position movement of the pin P in a groove part of the shift lever 10 is necessary. As a result, a sliding part is present, noise is generated due to an increase in an angular acceleration of the weight 20 until completion of a shift from a neutral stage and separation force is generated due to a difference between a direction in which force of the shift lever 10 acts and a direction in which the weight 20 is rotated at the time of returning to the neutral state after the completion of the shift.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made to solve at least some of the above-mentioned problems occurring in the prior art while advantages achieved by the prior art are maintained intact.

Various aspects of the present invention provide for a rotating structure of a weight for a manual transmission capable of increasing rotational inertial force of the weight through a gear ratio by gear-combining a shift lever and the weight of a control mechanism of the manual transmission with each other.

In various aspects of the present invention, there is provided a rotating structure of a weight for a manual transmission, including: a shift lever connected to a control shaft mounted in a control housing of the manual transmission and binding a shift stage selected by a select lever; a first gear part inserted into the control shaft to be operated together with the shift lever and having gears formed on an outer peripheral surface thereof; a weight provided at one end of the shift lever and increasing rotational inertial force of the shift lever; and a second gear part connected to the weight and having gears formed on an outer peripheral surface thereof to be engaged with the first gear part.

A ratio of the gears of the first gear part to the gears of the second gear part may be set to be larger than 1. The first and second gear parts may be positioned in the control housing.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a rotating structure of a weight for a manual transmission according to the related art;

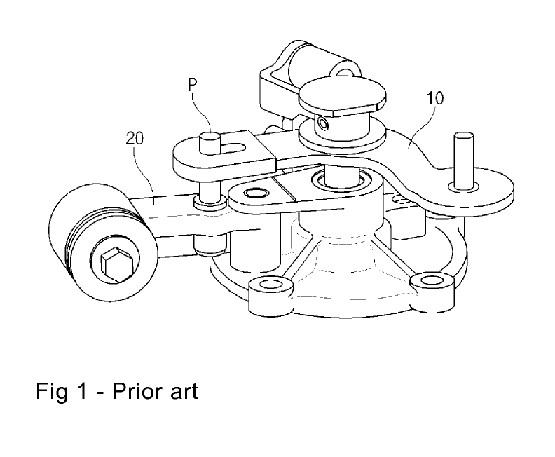

FIG. 2 is a view showing rotation directions of a shift lever and a weight of the rotating structure of a weight for a manual transmission according to the related art;

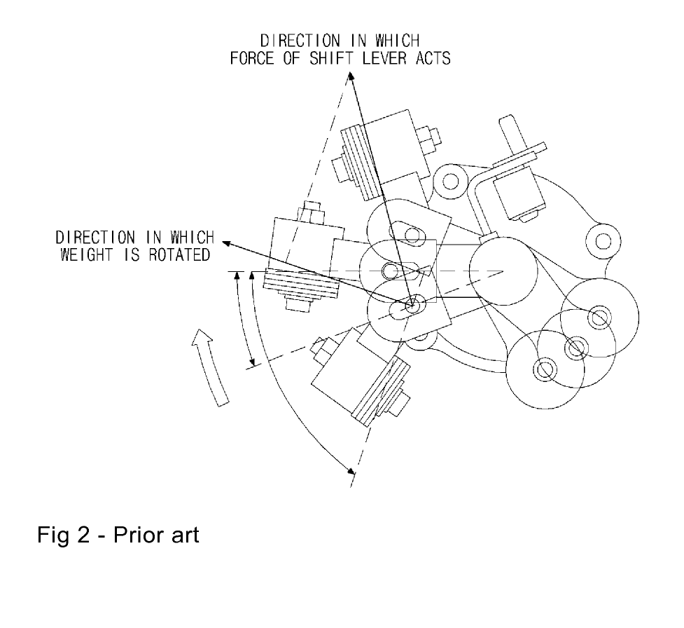

FIG. 3 is a view showing a rotating structure of a weight for a manual transmission according to the present invention; and

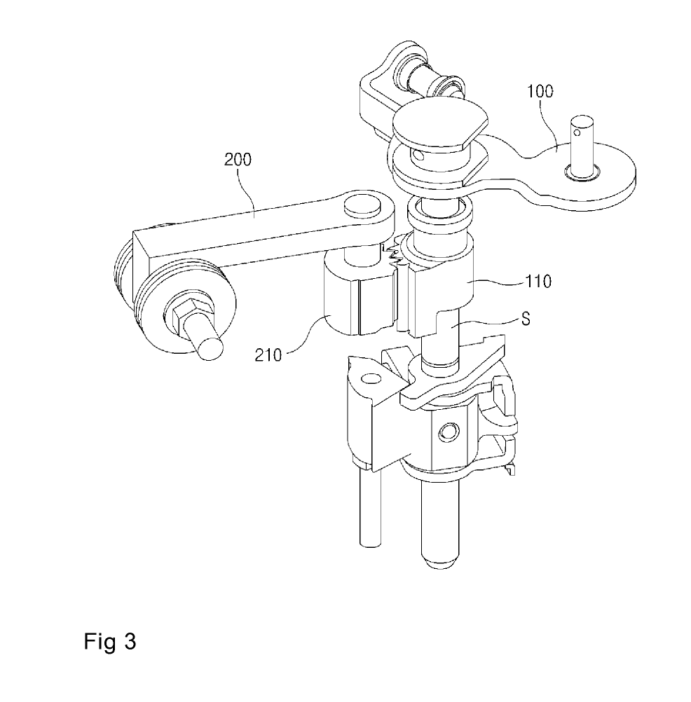

FIG. 4 is a view showing rotation amounts of a shift lever and a weight of the rotating structure of a weight for a manual transmission according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A rotating structure of a weight for a manual transmission according to various exemplary embodiments of the present invention is configured to include a shift lever 100 connected to a control shaft S, a first gear part 110 operated together with the shift lever 100, a weight 200 provided at one end of the shift lever 100, and a second gear part 210 operated together with the weight 200 and the first gear part 110.

The shift lever 100 is connected to the control shaft S mounted in a control housing of the manual transmission and binds a shift stage selected by a select lever. Here, the select lever and the shift lever 100 are connected to each other through the control shaft S mounted in the control housing, and the control shaft S is connected to the select lever and the shift lever 100 in the control housing and allows the shaft stage to be selected and bound.

Meanwhile, the select lever is connected to the control shaft S and allows the shift stage to be selected, and the shift lever 100 is connected to the control shaft S and allows the shift state to be bound. Here, the select lever and the shift lever 100 are connected to a change lever manipulated by a driver by a control cable.

The first gear part 110 has a hole formed in an inner peripheral surface thereof to allow the control shaft S to be inserted thereinto and has a plurality of gears formed on an outer peripheral surface thereof. Therefore, the shift lever 100 connected to the control shaft S and the first gear part 110 are operated together with each other, such that the first gear part 110 may also be rotated at the time of rotation of the shift lever 100.

The weight 200, which has a bar shape and has a shaft provided at one end thereof and a weight body mounted at the other end thereof to increase rotational inertial force of the shift lever 100, is not directly connected to the shift lever 100, but is separately provided at one end of the shift lever 100 and is connected to the shift lever 100 through a second gear part 210 to be described below.

The second gear part 210 has a hole formed in an inner peripheral surface thereof to allow the shaft S formed at one end of the weight 200 to be inserted thereinto, such that it may be connected to the weight 200 and has a plurality of gears formed on an outer peripheral surface thereof, such that it may be engaged with the first gear part 110.

As a result, according to various exemplary embodiments of the present invention, the shift lever 100 is provided with the first gear part 110, the weight 200 is provided with the second gear part 210, and the first and second gear parts 110 and 210 are engaged with each other, such that rotational force of the shift lever 100 is transferred to the weight 200 through the first and second gear parts 110 and 210 at the time of the rotation of the shift lever 100.

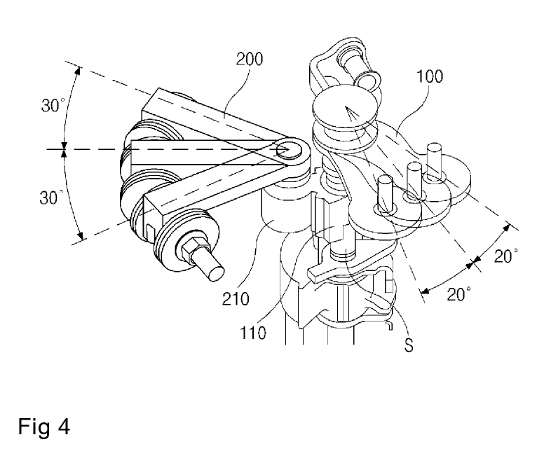

Here, as shown in FIG. 4, a ratio of the gears of the first gear part 110 to the gears of the second gear part 210 is set to be larger than 1 to allow a rotation speed of the weight 200 to be increased according to the ratio, thereby making it possible to increase an angular momentum. More specifically, in some embodiments, the ratio of the gears of the first gear part 110 to the gears of the second gear part 210 is set to be 3:2.

Meanwhile, although the shift lever 100 and the weight 200 are exposed to the outside of the transmission, the first and second gear parts 110 and 210 that are slidable are positioned in the control housing, such that a non-exposed structure is formed to prevent corrosion due to moisture or a pollutant, thereby making it possible to improve marketability.

As set forth above, according to various exemplary embodiments of the present invention, the shift lever and the weight are gear-combined with each other to increase the rotational inertial force of the weight through a gear ratio, thereby making it possible to improve operability and improve shift feeling due to transfer of force through the gears at the time of returning to a neutral stage after completion of a shift. In addition, since the gear parts are disposed in the control housing, a sliding part is not exposed to the outside, such that the possibility of corrosion and pollution is low, thereby making it possible to increase marketability.

For convenience in explanation and accurate definition in the appended claims, the terms “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A rotating structure of a weight for a manual transmission, comprising:
a shift lever connected to a control shaft mounted in a control housing of the manual transmission and binding a shift stage selected by a select lever;
a first gear part inserted into the control shaft to be operated together with the shift lever and having gears formed on an outer peripheral surface thereof;
a weight provided at one end of the shift lever and increasing rotational inertial force of the shift lever; and
a second gear part connected to the weight and having gears formed on an outer peripheral surface thereof to be engaged with the first gear part.

2. The rotating structure of a weight for a manual transmission according to claim 1, wherein a ratio of the gears of the first gear part to the gears of the second gear part is set to be larger than 1.

3. The rotating structure of a weight for a manual transmission according to claim 1, wherein the first and second gear parts are positioned in the control housing.
